(19) United States
(12) Patent Application Publication
(10) Pub. No.: US 2026/0288929 A1
(43) Pub. Date: Sep. 24, 2026

(54) INTELLIGENT MANAGEMENT OF PERMISSIONS WHILE FIXING BUGS

(71) Applicant: INTERNATIONAL BUSINESS MACHINES CORPORATION, ARMONK, NY (US)

(72) Inventors: Jin Xu, Xi'an (CN); Chong Liu, Xi'an (CN); Xu Lu, Xi'an (CN); Xiao Kou, Xi'an (CN); Qi Mao, Xi'an (CN); Chao Li, Xi'an (CN); A Long Zhi, Xi'an (CN)

(21) Appl. No.: 19/082,600

(22) Filed: Mar. 18, 2025

(51) Int. Cl. G06F 21/44

(52) U.S. Cl. CPC G06F 21/44

(57) ABSTRACT

Provided are techniques for intelligent management of permissions while fixing bugs. A description and comments associated with a bug are sent as input to a permissions Artificial Intelligence (AI) model. One or more permissions to at least one of a system and data for use in fixing the bug are received from the permissions AI model. Approval of the one or more permissions is obtained. An access token is created to associate the one or more permissions with the bug. The one or more permissions of the access token are assigned to a bug fixer. The bug fixer is invoked to fix the bug. An indication is received that the bug has been fixed. The one or more permissions are revoked from the bug fixer.

### BACKGROUND

Embodiments of the invention relate to intelligent management of permissions while fixing bugs. In particular, embodiments of the invention relate to intelligent management of permissions in the life cycle of bugs.

When many developers work on a product, the developers may divide the product into multiple modules according to the function and operating environment, then appropriate developers are assigned to complete the development work according to the workload of different modules. Before starting to develop products, developers apply for access to systems and/or data according to their work needs.

### SUMMARY

In accordance with certain embodiments, a computer-implemented method is provided for intelligent management of permissions while fixing bugs. In such embodiments, a description and comments associated with a bug are sent as input to a permissions Artificial Intelligence (AI) model. One or more permissions to at least one of a system and data for use in fixing the bug are received from the permissions AI model. Approval of the one or more permissions is obtained. An access token is created to associate the one or more permissions with the bug. The one or more permissions of the access token are assigned to a bug fixer. The bug fixer is invoked to fix the bug. An indication is received that the bug has been fixed. The one or more permissions are revoked from the bug fixer.

In accordance with yet other embodiments, a computer system comprises a processor set, one or more computer-readable storage media, and program instructions stored on the one or more computer-readable storage media executable by the processor set to perform one or more operations for intelligent management of permissions while fixing bugs. In such embodiments, a description and comments associated with a bug are sent as input to a permissions Artificial Intelligence (AI) model. One or more permissions to at least one of a system and data for use in fixing the bug are received from the permissions AI model. Approval of the one or more permissions is obtained. An access token is created to associate the one or more permissions with the bug. The one or more permissions of the access token are assigned to a bug fixer. The bug fixer is invoked to fix the bug. An indication is received that the bug has been fixed. The one or more permissions are revoked from the bug fixer.

In accordance with yet other embodiments, a computer system comprises a processor set; one or more computer-readable storage media; and program instructions stored on the one or more computer-readable storage media to cause the processor set to perform operations for intelligent management of permissions while fixing bugs. In such embodiments, a description and comments associated with a bug are sent as input to a permissions Artificial Intelligence (AI) model. One or more permissions to at least one of a system and data for use in fixing the bug are received from the permissions AI model. Approval of the one or more permissions is obtained. An access token is are created to associate the one or more permissions with the bug. The one or more permissions of the access token are assigned to a bug fixer. The bug fixer is invoked to fix the bug. An indication is received that the bug has been fixed. The one or more permissions are revoked from the bug fixer.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment for an access manager in accordance with certain embodiments.

FIG. 3 illustrates approvers data in accordance with certain embodiments.

FIG. 4 illustrates developers data in accordance with certain embodiments.

FIG. 5 illustrates a developers weight table in accordance with certain embodiments.

FIG. 6 illustrates, in a flowchart, operations for building and maintaining a permissions Artificial Intelligence (AI) model in accordance with certain embodiments.

FIGS. 7A and 7B illustrate, in a flowchart, operations for using the permissions AI model in accordance with certain embodiments.

FIG. 8 illustrates changes to the status of the bug and corresponding changes to an associated permission in accordance with certain embodiments.

FIG. 9 illustrates, in a flowchart, operations for intelligent management of permissions while fixing bugs in accordance with certain embodiments.

FIG. 10 illustrates, in a block diagram, details of a machine learning model 1000 in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

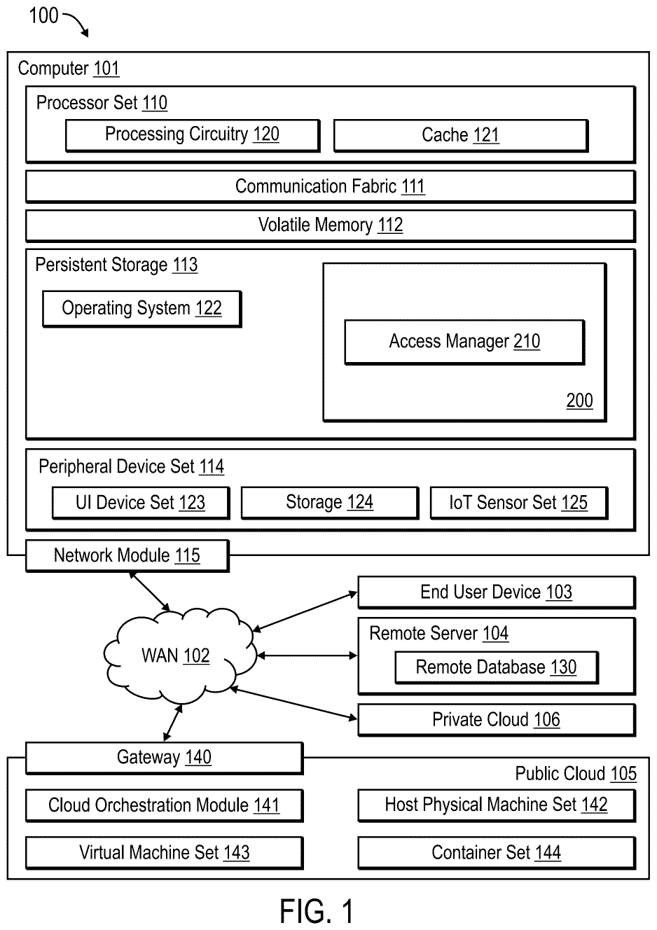

Computing environment 100 of FIG. 1 contains an example of an environment for the execution of at least some of the computer code involved in performing the inventive methods, such as access manager 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some cases, a developer is assigned to fix a bug for a customer, and the developer does not have access to customer data. Then, the developer may apply for a temporary permission by creating a ticket. However, this ticket may need approval from multiple approvers for the temporary permission. In addition, fixing the bug may require access to several systems, thus requiring multiple tickets. This increases the time to fix the bug.

In other cases, there is a team with multiple developers, and an individual developer of the team may not have access to all systems needed to fix a bug due to policy, security, location or legal requirements. Since there are may be a bug that requires access to one or several specific systems to investigate and fix that bug, the owner of the bug applies for temporary permissions of the systems with a ticket. If this bug requires multiple developers to work together, the owner has to apply for temporary permissions for each of the developers with a separate ticket. Then, the developers have to wait for approval of the permissions before beginning to work on the bug.

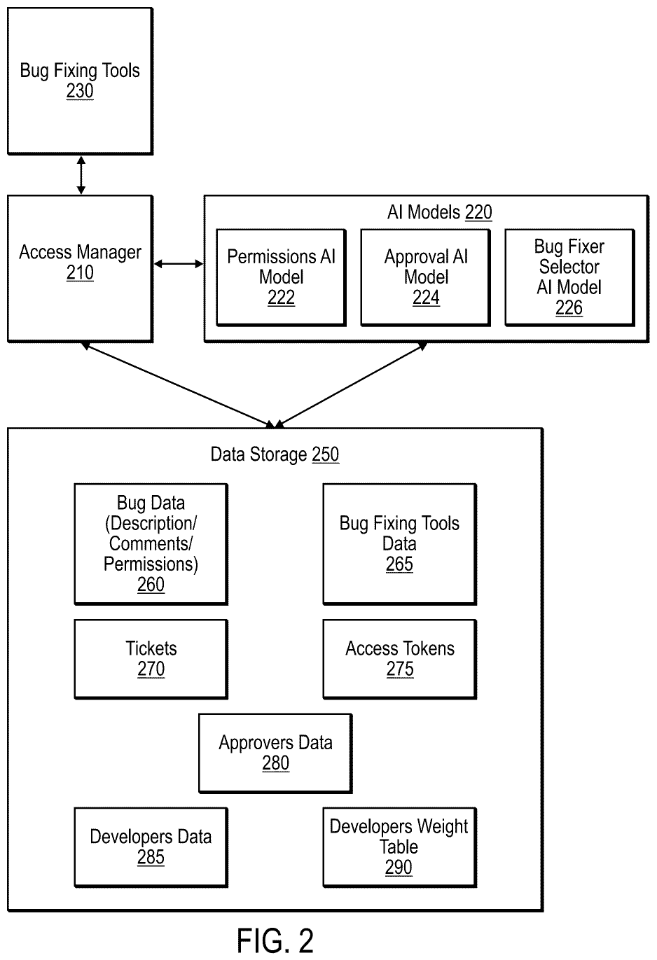

FIG. 2 illustrates a computing environment for an access manager 210 in accordance with certain embodiments. The access manager 210 is connected to Artificial Intelligence (AI) models 220, a bug fixing tool 230, and data storage 250. The AI models 220 include a permissions Artificial Intelligence (AI) model 222, an approval AI model 224, and a bug fixer selector AI model 226.

The access manager 210 uses the permissions AI model 222 to generate the permissions needed to access the systems and/or data that are to be accessed to fix the bug. In certain embodiments, the bug is a software bug (e.g., an issue to be fixed in software). The access manager 210 uses the approval AI model 224 to obtain approval to provide the permissions to a bug fixer. The access manager 210 uses the bug fixer selector AI model 226 to select the bug fixer.

In certain embodiments, the access manager 210 works with bug fixing tools 230 (i.e., implemented in software or code) to fix the bug. In other embodiments, the access manager works with a human developer to fix the bug. That is, the access manager 210 may invoke a bug fixer to fix the bug. In various embodiments, the bug fixer may be one or more bug fixing tools selected from the bug fixing tools 230, one or more human developers identified using the developers data 285 or a combination of one or more bug fixing tools and one or more human developers.

The data storage 250 includes bug data 260 (i.e., metadata including a description of the bugs, comments associated with the bugs, and permissions associated with the bugs), bug fixing tools data 265, tickets 270, access tokens 275, approvers data 280, developers data 285, and a developers weight table 290. The bug data 260 for a bug includes a description of the bug and comments regarding that bug, along with permissions to systems and/or data previously used to fix that bug. The approvers data 280 provides approvers and metadata for those approvers, such as permissions they already have to systems and/or data, locations, and levels. The approvers data 280 may also indicate which permissions were approved for bugs and which permissions were denied for bugs. The developers data 285 provides developers and metadata for those developers, such as permissions they already have to systems and/or data, the number of years the developer has worked in a particular software product or a particular field fixing bugs for that software product or fixing bugs in that field, the number of bugs currently assigned to the developer, and team that the developer is on, and the squad that the developer is on.

The access manager 210 reduces the time it takes to obtain permissions to systems and/or to data to fix bugs by pre-determining permissions for bugs using the permissions AI model 222. In certain embodiments, a permission refers to access to systems and/or data via an access token (i.e., an admin access token). In addition, the permissions AI model 222 indicates for a permission whether that permission is to be read-only or read-write.

In certain embodiments, the access token is a hash value, and the hash value identifies a system and/or data, including the system and/or data name, permissions (e.g., read-only permissions, read-write permissions, super permissions, etc.), bug identifier (ID), etc. In certain embodiments, one access token may be associated with one or more permissions. In certain embodiments, when a bug is assigned to one or more developers and/or bug fixing tools, the access manager 210 identifies new access permissions that are to be newly applied for based on the developer's data (e.g., based on what permissions that the developer already has, what permissions are available via the access token, and what permissions are still needed to fix the bug), and then the access manager 210 automatically invokes the access token to apply for these new access permissions.

In certain embodiments, the access manager 210 categorizes the approvers and developers according to their metadata. The categorization for an approver may be based on the location of the approver and level of an approver. A level may be described as a position of the approver in a hierarchy, and multiple approvers may be identified to authorize permissions. These multiple approvers may be at one level of the hierarchy or at different levels of the hierarchy. A hierarchy may include one more approvers at a first (“root”) level, one or more approvers at a second (“child”) level, etc. Also, the level may indicate a position of the approver, such as first line manager or second line manager.

The categorization for a developer may be based on permissions the developer already has to systems and/or data, the location of the developer, and the amount of experience the developer has. In certain embodiments, the access manager 210 identifies an approver and a developer who already have permissions to access the systems and/or data to fix the bug and are located near each other or in a same time zone so that they may communicate better. In certain embodiments, the access manager 210 creates an approver/developer database with the approvers data 280 and the developers data 285.

Once a bug is identified, the access manager 210 also analyzes the description and comments of the bug in an intelligent way, so as to find the permissions (i.e., access rights) that may be needed using the permissions AI model 222. This analysis may be based on comments obtained during the life cycle of the bug (e.g., from the time of creating a bug to assigning the bug to a bug fixer to having the bug fixed). The access manager 210 automatically submits one or more tickets to apply for temporary permissions. In certain embodiments, a ticket includes: the name and/or ID of each system to be accessed, the product name of the software where the bug was discovered, the bug ID of the bug, etc. In certain embodiments, the information on the ticket is used by an approver to determine whether to approve a permission for a particular bug and/or a particular bug fixer.

Once the ticket is approved, the access manager 210 creates an access token. Upon creation of the access token, the access manager 210 finds and recommends a bug fixer based on the permissions and assigns the bug to the bug fixer. The access manager 210 uses the saved access token to assign temporary permissions to bug fixer.

When the bug is assigned to a bug fixer, the access manager 210 also assigns the temporary permissions to the bug fixer. If the bug fixer applies for new permissions during the bug fixing, then the access manager 210 finds the nearest approvers based on the metadata of the approvers to request and obtain approval quickly for the new permissions. In certain embodiments, to request new permissions, the bug fixer adds a comment to this bug for the new permissions, then the access manager 210 uses an existing access token to obtain the new permissions.

Moreover, if a bug fixer is unassigned from fixing this bug, the access manager 210 automatically revokes the temporary permissions. In addition, when the bug is closed (e.g., the bug fix is complete and has been applied), the access manager 210 automatically revokes the temporary permissions.

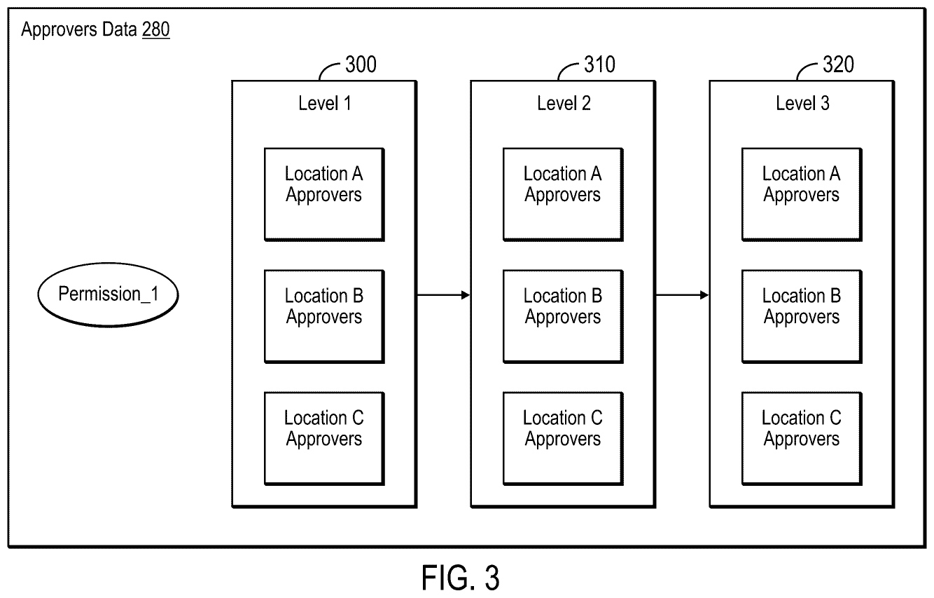

FIG. 3 illustrates approvers data 280 in accordance with certain embodiments. In certain embodiments, the access manager 210 stores the approvers data 280 in an approvers database according to the location and level of each approver so that the approver may be found more quickly. The approver either approvers or disapproves of providing the permissions so that the bug may be fixed.

In FIG. 3, permission_1 is assigned to a particular approver at a particular level. Also, approvers are identified for each level 300, 310, 320 and each location (locations A, B, and C). For example, permission_1 may be assigned to a location B approver of Level 1 based on the approver's current time, location (e.g., time zone), and response time (e.g., how busy the approver is approving other requests. If the permission needs multiple levels of approval, the access manager 210 requests approval from approvers at multiple levels (e.g., Level 2 and Level 3).

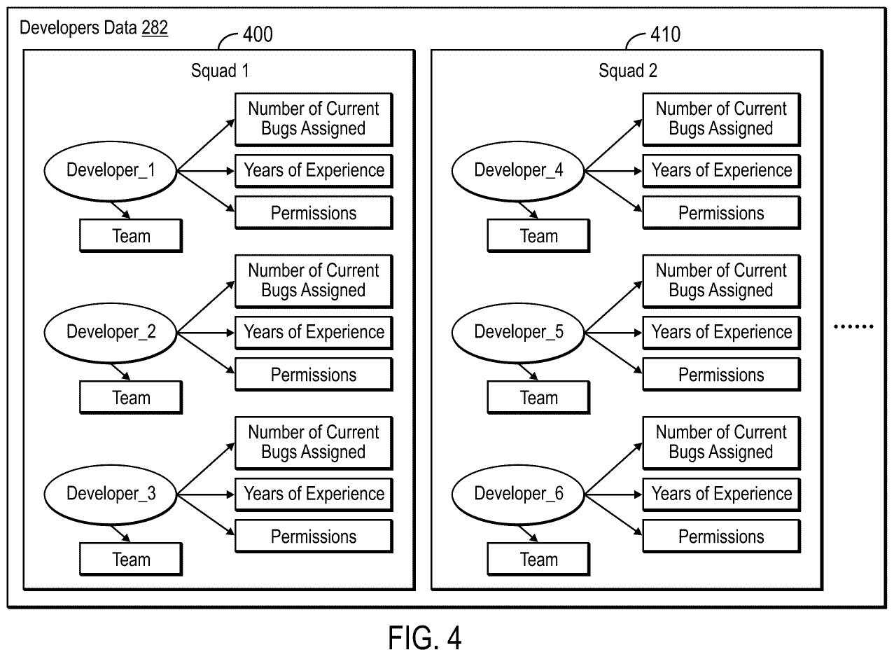

FIG. 4 illustrates developers data 285 in accordance with certain embodiments. In certain embodiments, the access manager 210 stores the developers data 285 in a developers database. The developers data 285 includes: the number of bugs currently assigned to the developer, the number of years the developer has experience on the software with the bug or in a particular field related to the bug, the permissions a developer has, and the team that the developer is on, as well as the current squad. In certain embodiments, a team is a group of developers working on a product (e.g., software). A team may include multiple squads (e.g., subsets) of developers. Each developer may work on different functionalities of the software. For example, some developers in a first squad are responsible for implementing function A, while other developers in a second squad are responsible for implanting function B.

In FIG. 4, Squad 1 400 includes developer_1, developer_2, and developer_3, while squad 2 410 includes developer_4, developer_5, and developer_6. In certain embodiments, a developer may be on more than one squad.

In order to avoid assigning bugs to one developer too frequently, the access manager 210 defines a dynamic weight for each developer and for each bug. If the weight value is the same for two developers, the access manager 210 assigns a bug to the developer with fewer bugs first.

In certain embodiments, a developer may be assigned several bugs, which means that the current number of bugs assigned to the developer is multiplied by the weight of the item. For example, if a developer has already been assigned 5 bugs and the weight of this item is 0.5, then N is 5*0.5. Then, the access manager may subtract N to avoid the problem of imbalanced bug assigning. With embodiments, N may be a preset value, which is set, for example, by a system administrator.

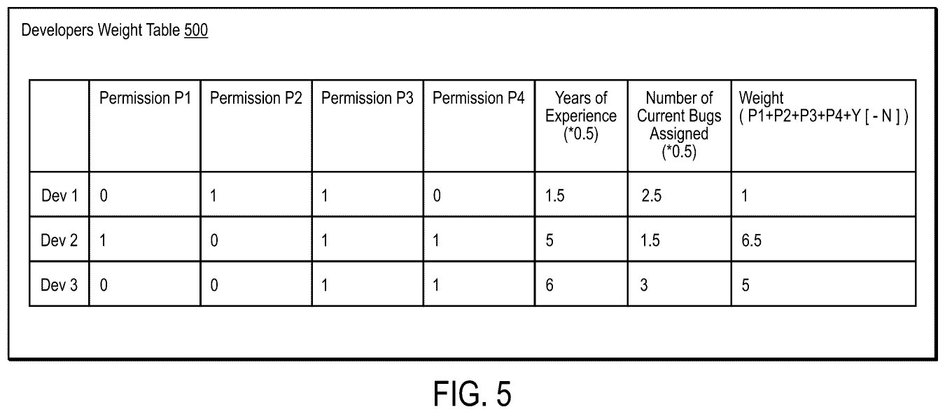

FIG. 5 illustrates a developers weight table 500 in accordance with certain embodiments. The developers weight table 500 is an example of a developers weight table 290. In FIG. 5, the developers weight table 500 includes a row for each developer. In addition, the developers weight table 500 includes columns for: the permission access for a first system P1, the permission access for a second system P2, the permission access for a third system P3, permission access for a fourth system P4, number of years the developer has worked, the number of bugs currently assigned to the developer, and the weight. To fix a bug, permissions to one to four systems may be needed.

In certain embodiments, if an urgent bug requires special handling, the access manager 210 assigns the bug to a more experienced developer. In such embodiments, the access manager 210 calculates the weight with: P1+P2+P3+P4+Y.

In certain embodiments, the access manager 210 may be described as a core management module with multiple functions. The access manager 210 uses the permissions AI model 222 for real-time analysis of input of the description and comments of a bug. The access manager 210 receives, from the permissions AI model 222, output of a prediction of the permissions required for to fix the bug. The access manager 210 submits a ticket to fix the bug based on the analysis results, finds approvers using the approvers data 280, and notifies the approvers to review and approve the ticket.

Once a ticket is approved, the access manager 210 saves an access token for the permissions so that the bug may be fixed. In certain embodiments, the access manager 210 finds the developer that best matches the bug requirements in the developer data 285 and checks the permissions that the current developer needs to fix the bug. The access manager 210 uses the access token to assign temporary permissions to the developer and assigns the bug to this developer.

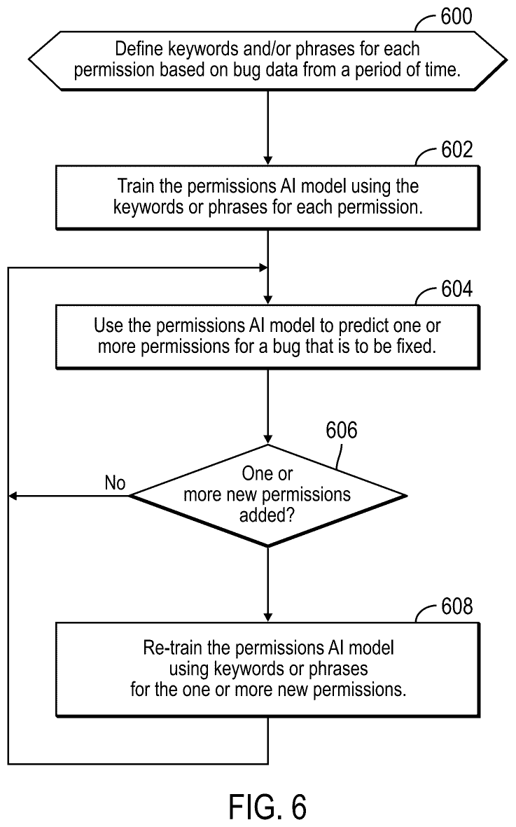

FIG. 6 illustrates, in a flowchart, operations for building and maintaining a permissions AI model 222 in accordance with certain embodiments. Control begins at block 600 with the access manager 210 retrieving keywords and/or phrases for each permission based on bug data 260 from a period of time (i.e., historical bug data). In certain embodiments, the keywords and phrases are defined based on the previously fixed bug descriptions, comments, and permissions. The period of time may be the past year or six months.

In block 602, the access manager 210 trains the permissions AI model 222 using the keywords and/or phrases for each permission. Because the keywords and/or phrases are generated, in part, based on the permissions associated with bugs, the permissions AI model 222 is trained to associate certain keywords and/or phrases in descriptions and comments with permissions so that the permissions AI model 222 is able to receive a new description and comments for a bug and predict permissions. For example, if the bug data 260 includes permission Y is needed to access System Z of Country X, then, if a description and comments for another bug indicates System Z of Country X, the permissions AI model 222 outputs permission Y. In certain embodiments, the access manager 210 trains and builds the permissions AI model 222 using the Naive Bayes technique, which uses probability to classify data.

In block 604, the access manager 210 uses the permissions AI model 222 to predict one or more permissions for a bug that is to be fixed.

During the use of the permissions AI model 222 or at some predetermined time (e.g., daily), the access manager 210 may determine whether one or more new permissions have been added (block 606). If so, processing continues to block 608, otherwise, processing loops back to block 604.

In block 608, the access manager 210 re-trains the permissions AI model using keywords or phrases for the one or more new permissions. From block 608, processing loops back to block 604.

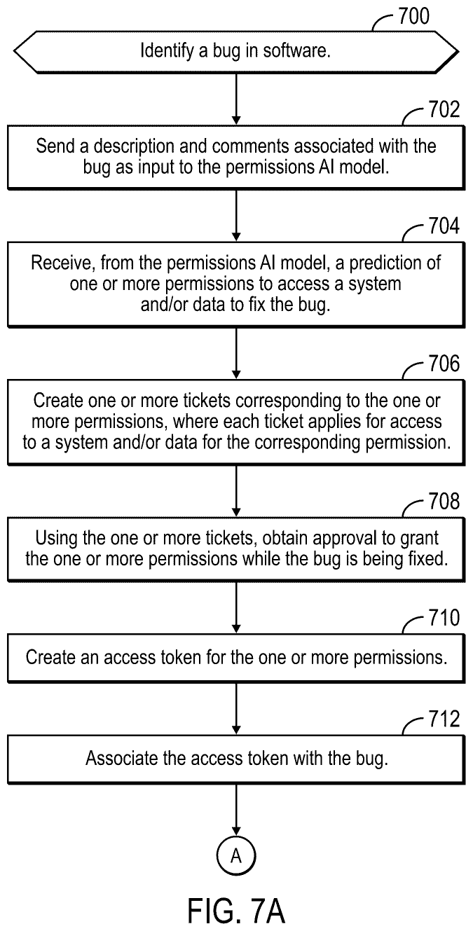

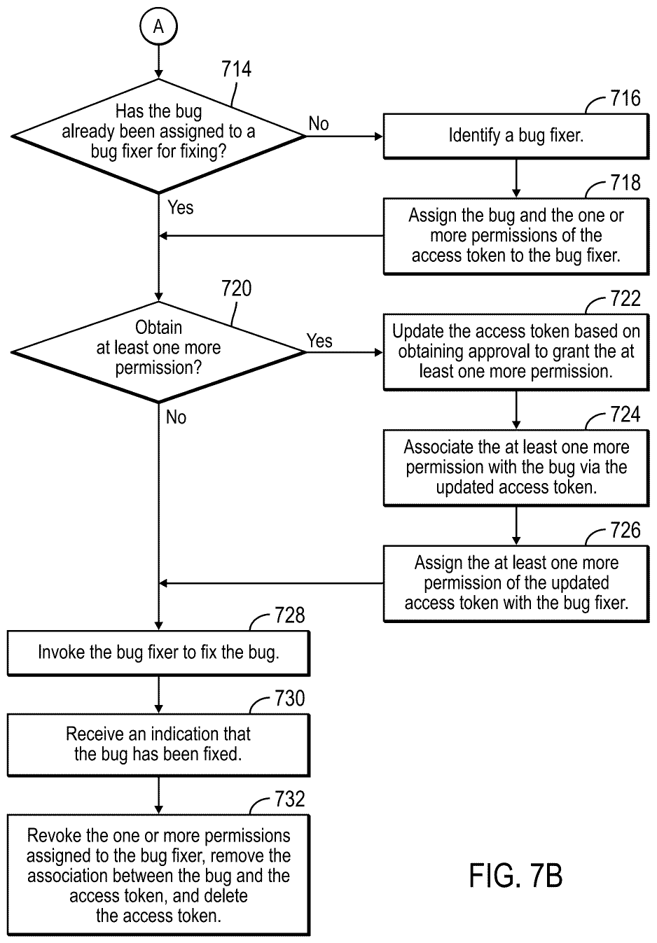

FIGS. 7A and 7B illustrate, in a flowchart, operations for using the permissions AI model in accordance with certain embodiments. Control begins at block 700 with the access manager 210 identifying a bug in software (e.g., based on user input). In certain embodiments, an internal user (e.g., a tester at a company where the software was created) or an external user (e.g., who purchased the software) provides a description of the bug with a request for a bug fix or with a report of a bug.

In block 702, the access manager 210 sends a description and comments associated with the bug as input to the permissions AI model 222. That is, the access manager 210 uses the permissions AI model 222 to analyze the description and comments of the bug. At this time, the description and comments of the bug are stored in the bug data 260, but the permissions are still to be determined. In block 704, the access manager 210 receives, from the permissions AI model 222, a prediction of one or more permissions to access a system and/or data to fix the bug. At this time, the one or more permissions are added to the bug data 260 for this bug.

In block 706, the access manager 210 creates one or more tickets corresponding to the one or more permissions, where each ticket applies for access to a system and/or data for the corresponding permission. For example, if 3 systems are to be accessed to fix the bug, the access manager 210 creates 3 tickets.

In block 708, using the one or more tickets, the access manager 210 obtains approval to grant the one or more permissions while the bug is being fixed. In certain embodiments, the access manager 210 inputs each of the one or more tickets to the approval AI model 224, and the approval AI model 224 outputs, to the access manager 210 an indication of approval (i.e., permission is granted) or disapproval (i.e., permission is not granted) for the corresponding permissions. In certain other embodiments, the access manager 210 identifies an approver from the approvers data 280, sends the one or more tickets to one or more identified approvers, and receives approval or disapproval. In certain embodiments, if the access manager 210 receives disapproval for the permissions, the access manager 210 may request additional information (e.g., from an approver) so that approval may be obtained.

In block 710, the access manager 210 creates an access token for the one or more permissions. The access manager 210 stores the access token in the data storage 250. In block 712, the access manager 210 associates the access token with the bug. From block 712 (FIG. 7A), processing continues to block 714 (FIG. 7B).

In block 714, the access manager 210 determines whether the bug has already been assigned to a bug fixer for fixing. If so, processing continues to block 720, otherwise, processing continues to block 716.

In block 716, the access manager 210 identifies a bug fixer. In certain embodiments, the access manager 210 inputs bug data 260, developers data 285, and the developers weight table 290 into the bug fixer selector AI model 226, and the bug fixer selector AI model 226 outputs a bug fixer (i.e., a bug fixing tool and/or a developer). In certain other embodiments, the access manager 210 identifies a bug fixing tool (as the bug fixer) using the bug fixing tools data 265. In yet other embodiments, the access manager 210 identifies a developer (i.e., as the bug fixer) using the developers data 285 and the developers weight table 290.

In block 714, the access manager 210 assigns the bug and the one or more permissions of the access token to the bug fixer. In certain embodiments, when assigning the bug to the bug fixer, the access manager 210 also obtains approval to assign the one or more permissions of the access token to the bug fixer. With embodiments, since the access token is associated with the bug, and fixing the bug needs access to system ABC, the access manager 210 stores the access token in data storage (e.g., a database) of system ABC. If this bug is assigned to bug fixer A and bug fixer B, then the bug fixers A and B do not need to separately apply for access to system ABC. Instead, the access manager 210 temporarily and automatically assigns the one or more permissions to the bug fixers A and B using the access token. From block 718, processing continues to block 720.

In block 720, the access manager 210 determines whether at least one more permission is to be obtained that the bug fixer does not already have and that is not associated with the access token. If so, processing continues to block 722, otherwise, processing continues to block 728. In block 722, the access manager 210 updates the access token based on obtaining approval to grant the at least one more permission. This updated access token is stored. In block 724, the access manager 210 associates the at least one more permission with the bug via the updated access token. In block 724, the access manager 210 assigns the at least one more permission of the updated access token with the bug fixer. From block 726, processing continues to block 728.

In block 728, the access manager 210 invokes the bug fixer to fix the bug. This may be done by invoking a bug fixing tool to fix the bug. Alternately, this may be by invoking the developer to fix the bug. In block 730, the access manager 210 receives an indication that the bug is fixed from the bug fixer. In block 732, the access manager 210 revokes the one or more permissions assigned to the bug fixer, removes the association between the bug and the access token, and deletes the access token.

In certain embodiments, if a new bug is added with a new description, a new comment is added to an existing bug, the access manager 210 automatically parses the new description or the new comment to identify any new system to be accessed, then the access manager 210 applies to update the access token with permission to access the new system (i.e., a previously unrecognized).

In certain embodiments, the access manager 210 automatically matches and assigns the bug fixer to track the bugs. In certain embodiments, the access manager 210 automatically assigns permissions without bug fixers having to apply for those permissions. In certain embodiments, the access manager 210 uses the permissions AI model 222, which is a pre-defined model.

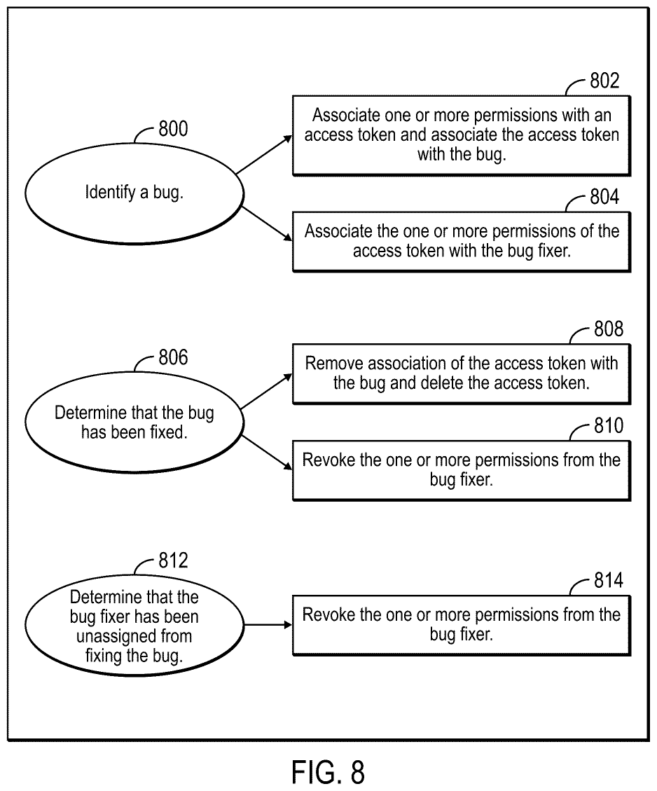

FIG. 8 illustrates changes to the status of the bug and corresponding changes to an associated permission in accordance with certain embodiments. If the bug status is that a bug has been identified (800), then the access manager 210 associates one or more permissions with an access token, and the access token is associated with the bug (802). In addition, the access token associates the one or more permissions of the access token with the bug fixer (804).

If the bug status is that the bug has been fixed (806), the access manager 210 removes the association of the access token with the bug and deletes the access token (808). In addition, the access manager 210 revokes the one or more permissions from the bug fixer (810).

If the bug status is that the bug fixer has been unassigned from fixing the bug (812), the access manager 210 revokes the one or more permissions from the bug fixer (814).

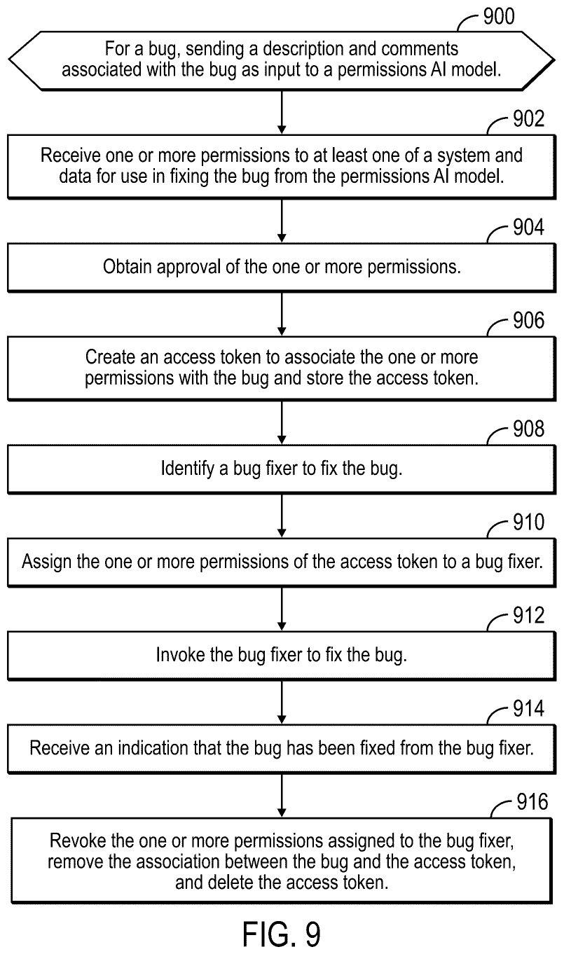

FIG. 9 illustrates, in a flowchart, operations for intelligent management of permissions while fixing bugs in accordance with certain embodiments. Control begins at block 900 with the access manager 210, for a bug, sending a description and comments associated with the bug as input to a permissions Artificial Intelligence (AI) model. In block 904, the access manager 210 receives one or more permissions to at least one of a system and data for use in fixing the bug from the permissions AI model. In block 904, the access manager 210 obtains approval of the one or more permissions. In block 906, the access manager 210 creates an access token to associate the one or more permissions with the bug and stores the access token. In block 908, the access manager 210 identifies a bug fixer to fix the bug. In block 910, the access manager 210 assigns the one or more permissions of the access token to a bug fixer. In block 912, the access manager 210 invokes the bug fixer to fix the bug. In block 914, the access manager 210 receives an indication that the bug has been fixed from the bug fixer. In block 916, the access manager 210 revokes the one or more permissions assigned to the bug fixer, removes the association between the bug and the access token, and deletes the access token.

Thus, in certain embodiments, the access manager 210 intelligently obtains permissions, which saves time to fix a bug. The access manager 210 automatically finds the appropriate bug fixers to fix the bug so that it is resolved faster. The access manager 210 automatically finds approvers to approve assignment of the permissions.

In addition, the access manager 210 recommends the one or more big fixers to fix the bug, reducing the effort of assigning bugs. Also, the access manager 210 pre-applies permissions before the bug is assigned to any bug fixers, which saves time and increases efficiency. Moreover, the access manager 210 associates the permissions with the bugs, not with any bug fixer. When the bug is associated with multiple bug fixers, there is no need for each bug fixer to apply for permission via multiple tickets. Furthermore, the access manager 210 automatically changes permissions based on the bug status, including applying for new permissions based on new bugs with a new description or new comments for an existing bug, assigning temporary permissions based on finding that additional permissions are needed by the bug fixer, revoking permissions, etc. For example, once a bug is fixed, the permissions assigned to the bug are revoked.

In certain embodiments, the access manager 210 may be used in multi-role permission control, such as Quality Assurance (QA), operation and maintenance, etc. The access manager 210 avoids the approvers receiving multiple tickets for permissions.

In certain embodiments, the access manager 210 intelligently manages permissions during the bug life cycle (from the beginning when the bug is identified till the bug is fixed), and the allocation of permissions is for this bug, rather than for a specified bug fixer. Therefore, if this bug requires multiple bug fixers to work together, there is no need for each of the multiple bug fixers to go through the application process to apply for permissions.

In addition, once the permissions are automatically found, the access manager 210 automatically finds the one or more approvers to approve the permissions and automatically finds the one or more bug fixers to fix the bug with those permissions. As the bug status changes, the access manager 210 updates the corresponding permissions.

With embodiments, the access manager 210 quickly finds relevant personnel (approvers and bug fixers) and avoids the time for multiple bug fixers to apply for permissions to system and/or data for the same bug, thus effectively improving work efficiency. Also, because the permissions are revoked with the bug closing, the access manager 210 prevents a bug fixer from having these permissions for a long time.

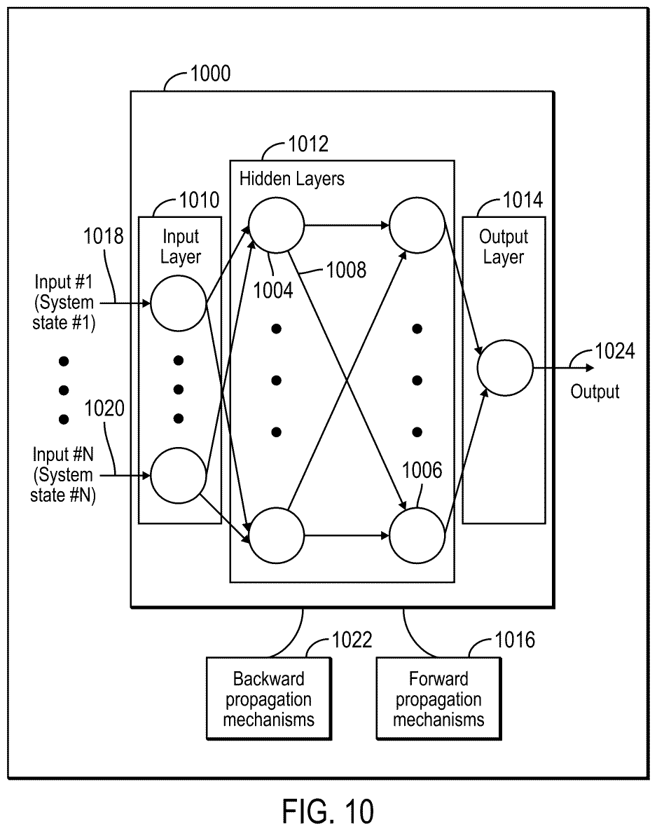

FIG. 10 illustrates, in a block diagram, details of a machine learning model 1000 in accordance with certain embodiments. In certain embodiments, the permissions AI model 222, the approval AI model 224, and the bug fixer selector AI model 226 are each implemented using the components of the machine learning model 1000.

The machine learning model 1000 may comprise a neural network with a collection of nodes with links connecting them, where the links are referred to as connections. For example, FIG. 10 shows a node 1004 connected by a connection 1008 to the node 1006. The collection of nodes may be organized into three main parts: an input layer 1010, one or more hidden layers 1012, and an output layer 1014.

The connection between one node and another is represented by a number called a weight, where the weight may be either positive (if one node excites another) or negative (if one node suppresses or inhibits another). Training the machine learning model 1000 entails calibrating the weights in the machine learning model 1000 via mechanisms referred to as forward propagation 1016 and backward propagation 1022. Bias nodes that are not connected to any previous layer may also be maintained in the machine learning model 1000. A bias may be described as an extra input of 1 with a weight attached to it for a node.

In forward propagation 1016, a set of weights are applied to the input data 1018 . . . 1020 to calculate the output 1024. For the first forward propagation, the set of weights may be selected randomly or set by, for example, a system administrator. That is, in the forward propagation 1016, embodiments apply a set of weights to the input data 1018 . . . 1020 and calculate an output 1024.

In backward propagation 1022 a measurement is made for a margin of error of the output 1024, and the weights are adjusted to decrease the error. Backward propagation 1022 compares the output that the machine learning model 1000 produces with the output that the machine learning model 1000 was meant to produce, and uses the difference between them to modify the weights of the connections between the nodes of the machine learning model 1000, starting from the output layer 1014 through the hidden layers 1012 to the input layer 1010, i.e., going backward in the machine learning model 1000. In time, backward propagation 1022 causes the machine learning model 1000 to learn, reducing the difference between actual and intended output to the point where the two come very close or coincide.

The machine learning model 1000 may be trained using backward propagation to adjust weights at nodes in a hidden layer to produce adjusted output values based on the provided input data 1018 . . . 1020. A margin of error may be determined with respect to the actual output 1024 from the machine learning model 1000 and an expected output to train the machine learning model 1000 to produce the desired output value based on a calculated expected output. In backward propagation, the margin of error of the output may be measured and the weights at nodes in the hidden layers 1012 may be adjusted accordingly to decrease the error.

Backward propagation may comprise a technique for supervised learning of artificial neural networks using gradient descent. Given an artificial neural network and an error function, the technique may calculate the gradient of the error function with respect to the artificial neural network's weights.

Thus, the machine learning model 1000 is configured to repeat both forward and backward propagation until the weights of the machine learning model 1000 are calibrated to accurately predict an output.

The machine learning model 1000 implements a machine learning technique such as decision tree learning, association rule learning, artificial neural network, inductive programming logic, support vector machines, Bayesian models, etc., to determine the output 1024.

In certain machine learning model 1000 implementations, weights in a hidden layer of nodes may be assigned to these inputs to indicate their predictive quality in relation to other of the inputs based on training to reach the output 1024.

With embodiments, the machine learning model 1000 is a neural network, which may be described as a collection of “neurons” with “synapses” connecting them.

With embodiments, there may be multiple hidden layers 1012, with the term “deep” learning implying multiple hidden layers. Hidden layers 1012 may be useful when the neural network has to make sense of something complicated, contextual, or non-obvious, such as image recognition. The term “deep” learning comes from having many hidden layers. These layers are known as “hidden”, since they are not visible as a network output.

In certain embodiments, training a neural network may be described as calibrating all of the “weights” by repeating the forward propagation 1016 and the backward propagation 1022.

In backward propagation 1022, embodiments measure the margin of error of the output and adjust the weights accordingly to decrease the error.

Neural networks repeat both forward and backward propagation until the weights are calibrated to accurately predict the output 1024.

In certain embodiments, the inputs to the permissions AI model 222 are bug description and comments, and the outputs of the machine learning model 1000 are one or more permissions to systems and/or data that are needed to fix the bug. In certain embodiments, the machine learning model 1000 may be refined based on whether the outputs, once taken, generate positive outcomes.

In certain embodiments, the inputs to the approval AI model 224 are one or more tickets corresponding to one or more permissions, and the output of the machine learning model 1000 is an approval or a disapproval for each of the one or more permissions. In certain embodiments, the machine learning model 1000 may be refined based on whether the outputs, once taken, generate positive outcomes.

In certain embodiments, the inputs to the bug fixer selector AI model 226 are bug data, developers data, and the developers weight table, and the outputs of the machine learning model 1000 are one or more bug fixers (i.e., bug fixing tools and/or developers). In certain embodiments, the machine learning model 1000 may be refined based on whether the outputs, once taken, generate positive outcomes.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method comprising:
sending a description and comments associated with a bug as input to a permissions Artificial Intelligence (AI) model;
receiving one or more permissions to at least one of a system and data for use in fixing the bug from the permissions AI model;
obtaining approval of the one or more permissions;
creating an access token to associate the one or more permissions with the bug;
assigning the one or more permissions of the access token to a bug fixer;
invoking the bug fixer to fix the bug;
receiving an indication that the bug has been fixed; and
revoking the one or more permissions from the bug fixer.

2. The computer-implemented method of claim 1, wherein the operations further comprise:
identifying one or more approvers to approve the one or more permissions using an approval AI model.

3. The computer-implemented method of claim 1, wherein the operations further comprise:
identifying the bug fixer using a bug fixer selector AI model, wherein the bug fixer comprises one of a bug fixing tool and a developer.

4. The computer-implemented method of claim 1, wherein the operations further comprise:
determining that an additional permission is to be obtained;
obtaining the additional permission;
associating the additional permission with the access token; and
assigning the additional permission of the access token to the bug fixer.

5. The computer-implemented method of claim 1, wherein the operations further comprise:
defining keywords or phrases for each of the one or more permissions based on data from a period of time; and
training the permissions AI model using the keywords or phrases for each of the one or more permissions.

6. The computer-implemented method of claim 5, wherein the operations further comprise:
determining that new permissions have been added; and
re-training the permissions AI model using keywords or phrases for the new permissions.

7. The computer-implemented method of claim 1, wherein the operations further comprise:
creating one or more tickets corresponding to the one or more permissions, where each of the one or more tickets applies for access to one of a system and data for the corresponding permission.

8. A computer program product comprising:
one or more computer-readable storage media; and
program instructions stored on the one or more computer-readable storage media executable by a processor to perform one or more operations, the computer program product comprising:
program instructions to send a description and comments associated with a bug as input to a permissions Artificial Intelligence (AI) model;
program instructions to receive one or more permissions to at least one of a system and data for use in fixing the bug from the permissions AI model;
program instructions to obtain approval of the one or more permissions;
program instructions to create an access token to associate the one or more permissions with the bug;
program instructions to assign the one or more permissions of the access token to a bug fixer;
program instructions to invoke the bug fixer to fix the bug;
program instructions to receive an indication that the bug has been fixed; and
program instructions to revoke the one or more permissions from the bug fixer.

9. The computer program product of claim 8, further comprising:
program instructions to identify one or more approvers to approve the one or more permissions using an approval AI model.

10. The computer program product of claim 8, further comprising:
program instructions to identify the bug fixer using a bug fixer selector AI model, wherein the bug fixer comprises one of a bug fixing tool and a developer.

11. The computer program product of claim 8, further comprising:
program instructions to determine that an additional permission is to be obtained;
program instructions to obtain the additional permission;
program instructions to associate the additional permission with the access token; and
program instructions to assign the additional permission of the access token to the bug fixer.

12. The computer program product of claim 8, further comprising:
program instructions to define keywords or phrases for each of the one or more permissions based on data from a period of time; and
program instructions to train the permissions AI model using the keywords or phrases for each of the one or more permissions.

13. The computer program product of claim 12, further comprising:
program instructions to determine that new permissions have been added; and
program instructions to re-train the permissions AI model using keywords or phrases for the new permissions.

14. The computer program product of claim 8, further comprise:
program instructions to create one or more tickets corresponding to the one or more permissions, where each of the one or more tickets applies for access to one of a system and data for the corresponding permission.

15. A computer system comprising:
a processor set;
one or more computer-readable storage media; and
program instructions stored on the one or more computer-readable storage media executable by the processor set to perform one or more operations comprising:
send a description and comments associated with the bug as input to a permissions Artificial Intelligence (AI) model;
receive one or more permissions to at least one of a system and data for use in fixing the bug from the permissions AI model;
obtain approval of the one or more permissions;
create an access token to associate the one or more permissions with the bug;
assign the one or more permissions of the access token to a bug fixer;
invoke the bug fixer to fix the bug;
receive an indication that the bug has been fixed; and
revoke the one or more permissions from the bug fixer.

16. The computer system of claim 15, further comprising operations to:
identify one or more approvers to approve the one or more permissions using an approval AI model.

17. The computer system of claim 15, further comprising operations to:
identifying the bug fixer using a bug fixer selector AI model, wherein the bug fixer comprises one of a bug fixing tool and a developer.

18. The computer system of claim 15, further comprising operations to:
determine that an additional permission is to be obtained;
obtain the additional permission;
associate the additional permission with the access token; and
assign the additional permission of the access token to the bug fixer.

19. The computer system of claim 15, further comprising operations to:
define keywords or phrases for each of the one or more permissions based on data from a period of time; and
train the permissions AI model using the keywords or phrases for each of the one or more permissions.

20. The computer system of claim 19, further comprising operations to:
determine that new permissions have been added; and
re-train the permissions AI model using keywords or phrases for the new permissions.
